(19) United States
(12) Patent Application Publication
(10) Pub. No.: US 2025/0363809 A1
(43) Pub. Date: Nov. 27, 2025

(54) ANOMALY MANAGEMENT SYSTEM

(71) Applicant: TOYOTA JIDOSHA KABUSHIKI KAISHA, Toyota-shi Aichi-ken (JP)

(72) Inventors: Yumi SATO, Suginami-ku Tokyo-to (JP); Takashi HOMMA, Koto-ku Tokyo-to (JP); Takahiro IWASAKI, Kiyose-shi Tokyo-to (JP); Bing XUE, Edogawa-ku Tokyo-to (JP)

(73) Assignee: TOYOTA JIDOSHA KABUSHIKI KAISHA, Toyota-shi Aichi-ken (JP)

(21) Appl. No.: 19/214,509

(22) Filed: May 21, 2025

(30) Foreign Application Priority Data
May 23, 2024 (JP) 2024-084193

(51) Int. Cl. G06V 20/58; G06V 10/764; G06V 20/40; G08G 9/02

(52) U.S. Cl. CPC G06V 20/58; G06V 10/764; G06V 20/44; G08G 9/02

(57) ABSTRACT

An anomaly management system includes one or more processors. The one or more processors are configured to execute: video acquisition processing of acquiring a video captured by a camera mounted on a moving body; anomaly event recognition processing of automatically recognizing an anomaly event shown in the video and content of the anomaly event by using a machine learning model; notification destination determination processing of automatically determining a notification destination according to the content of the anomaly event; and notification processing of automatically transmitting to the notification destination, anomaly event information including at least information indicating the content of the anomaly event and position information indicating a position of the anomaly event.

### CROSS-REFERENCES TO RELATED APPLICATION

The present disclosure claims priority under 35 U.S.C. § 119 to Japanese Patent Application No. 2024-084193, filed on May 23, 2024, which is incorporated herein by reference in its entirety.

### BACKGROUND

### Technical Field

The present disclosure relates to an anomaly management system applied to a moving body.

### Background Art

JP 2021-043552 A discloses an information processing system including an information processing device and an in-vehicle device. The in-vehicle device detects that a vehicle equipped with the in-vehicle device is tailgated by another vehicle. The information processing device receives an event detection notification from the in-vehicle device. When determining that the tailgating is correct, the information processing device notifies at least one of a security company and a police.

Moreover, each of JP 2021-165906 A, JP 2019-179313 A, JP 1999-345385 A, and JP 1995-220191 A discloses a technique for addressing an anomaly event (for example, tailgating or a traffic accident) encountered by a vehicle.

### SUMMARY

While driving a moving body such as a vehicle, a driver may find various surrounding anomaly events. However, it is difficult for the driver to make a notification while driving. Also, the anomaly event is not limited to tailgating, and the contents thereof are various. Therefore, the appropriate notification destination may not be one type. Even if the driver decides to make a notification, the driver may not immediately know where to notify depending on the contents of the anomaly event. If the notification is made to an inappropriate notification destination, a notification delay and unnecessary confusion may be caused.

An anomaly management system according to the present disclosure includes one or more processors. The one or more processors are configured to execute: video acquisition processing of acquiring a video captured by a camera mounted on a moving body; anomaly event recognition processing of automatically recognizing an anomaly event shown in the video and content of the anomaly event by using a machine learning model; notification destination determination processing of automatically determining a notification destination according to the content of the anomaly event; and notification processing of automatically transmitting to the notification destination, anomaly event information including at least information indicating the content of the anomaly event and position information indicating a position of the anomaly event.

According to the present disclosure, an anomaly event is automatically recognized from a video captured by a camera, and a notification is automatically made. Therefore, a driver who is driving does not need to make a notification. Further, the notification destination according to the content of the anomaly event is automatically determined, and the notification is appropriately performed to the appropriate notification destination. Therefore, a notification delay and an unnecessary confusion are reduced or prevented. Furthermore, the anomaly event information including the content and the position of the anomaly event is automatically transmitted to the notification destination. Therefore, the driver does not need to explain each anomaly event one by one.

### BRIEF DESCRIPTION OF THE DRAWINGS

FIG. 1 is a diagram used to describe an overview of an anomaly management system according to the present disclosure;

FIG. 2 is a block diagram showing a configuration example of an anomaly management system according to a first embodiment;

FIG. 3 is a flowchart illustrating an example of a flow of processing related to management of an anomaly event according to the first embodiment;

FIG. 4 is a block diagram showing a configuration example of an anomaly management system according to a second embodiment; and

FIG. 5 is a flowchart illustrating an example of a flow of processing related to management of an anomaly event according to the second embodiment.

### DETAILED DESCRIPTION

Embodiments of the present disclosure will be described with reference to the accompanying drawings.

### [Overview of Anomaly Management System]

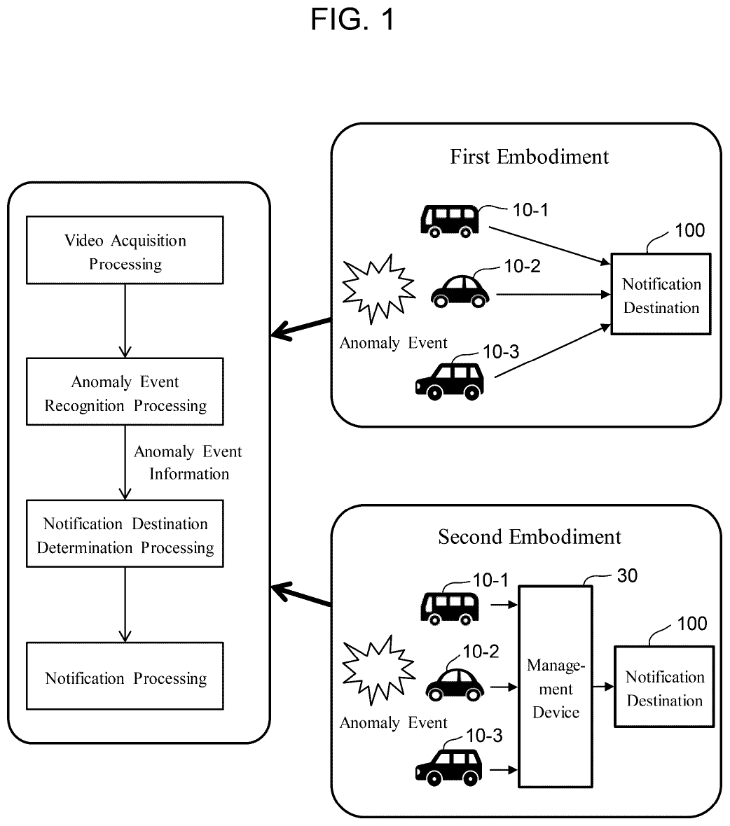

FIG. 1 is a diagram used to describe an overview of an anomaly management system according to the present disclosure. The anomaly management system is applied to a moving body. Examples of the moving body include a vehicle, a robot, and a flying object (for example, a drone). In the following description, a vehicle 10 is taken as an example of the moving body to which the anomaly management system is applied. When generalizing, “vehicle” in the following description is replaced with “moving body”.

The processing executed in the anomaly management system includes four kinds of processing shown in FIG. 1, that is, “video acquisition processing”, “anomaly event recognition processing”, “notification destination determination processing”, and “notification processing”.

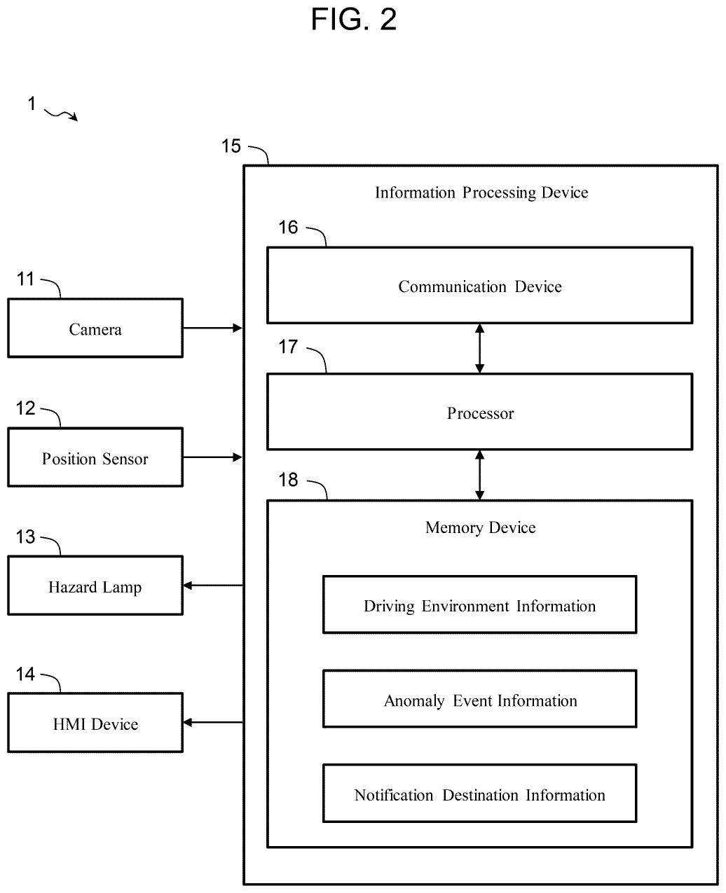

A camera 11 (see FIG. 2) is mounted on the vehicle 10. The camera 11 acquires a video V indicating a situation around the vehicle 10. The video acquisition processing is processing of acquiring the video V captured by the camera 11.

The anomaly event recognition processing is processing of automatically recognizing an anomaly event shown in the video V of the camera 11 and the content thereof by using a machine learning model. Examples of the anomaly event include a traffic accident, a fire, a crime/incident (for example, vehicle break-in, theft, tailgating), an illness, a lost item on a road, flooding of a road, and rising waters of a river. The position where the anomaly event occurs may not move. Further, the same anomaly event may be commonly recognized by a plurality of vehicles 10 (e.g., vehicles 10-1, 10-2, and 10-3). In addition, as described above, the recognition of the anomaly event by the anomaly event recognition processing includes the recognition of an anomaly event (for example, tailgating) of a target vehicle by the target vehicle, and the recognition of an external anomaly event (i.e., an anomaly event occurring around the target vehicle) by the target vehicle.

Anomaly event information is information related to an anomaly event recognized by the anomaly event recognition processing. The anomaly event information includes at least information indicating the content of the anomaly event and position information indicating the position of the anomaly event. Examples of the content of the anomaly event include the type, the situation, and the scale of the anomaly event.

More specifically, the information indicating the content of the anomaly event is acquired from the recognition result of the anomaly event recognition processing. Also, the position of the anomaly event can be calculated by combining the position of the vehicle 10 and the position of the anomaly event in the video V of the camera 11. Further, the position of the vehicle 10 may be approximately regarded as the position of the anomaly event. That is, the position of the vehicle 10 acquired when the anomaly event is recognized may be used as the position of the anomaly event.

Moreover, the anomaly event information may include the video V of a target period of time including at least a timing at which the anomaly event is recognized by the anomaly event recognition processing. Furthermore, the anomaly event information may include time information indicating a point of time at which the anomaly event is recognized.

The notification destination determination processing is processing of automatically determining a notification destination 100 according to the content of the anomaly event included in the anomaly event information. In order to determine the notification destination 100 in the notification destination determination processing, for example, a machine learning model may be used, or a rule-based artificial intelligence (AI) technique may be used. The notification destination 100 is exemplified by organizations, such as police, fire department, road manager, and local government. More specifically, the correspondence between the anomaly event and the notification destination 100 is as follows, for example.
Traffic accident: Police and/or Fire Department
Fire: Fire Department
Crime/Incident: Police
Illness: Emergency Medical Service and/or Fire Department
Lost Item on Road: Road Manager
Flooding of Road or Rising Waters of River: Local Government

The notification processing is processing of automatically transmitting the anomaly event information to the notification destination 100 determined by the notification destination determination processing.

The anomaly management system according to the present disclosure may be mounted on the vehicle 10 as described in a first embodiment. In the first embodiment, all of the four kinds of processing are executed by the information processing device 15 mounted on the vehicle 10. That is, all of the four kinds of processing are completed in the vehicle 10.

Alternatively, the anomaly management system according to the present disclosure may include an in-vehicle system 20 (a system mounted on a moving body) and a management device 30 as described in a second embodiment. In the second embodiment, the four kinds of processing are executed by the in-vehicle system 20 and the management device 30 in cooperation with each other. Specifically, the in-vehicle system 20 executes the video acquisition processing and the anomaly event recognition processing. The in-vehicle system 20 transmits the anomaly event information to the management device 30. The management device 30 receives the anomaly event information from the in-vehicle system 20 and executes the notification destination determination processing and the notification processing. As described above, in the second embodiment, the management device 30 is interposed between a plurality of vehicles 10 and the notification destination 100, and the management device 30 makes the notification as a representative.

### 1. First Embodiment

### 1-1. Configuration Example

FIG. 2 is a block diagram showing a configuration example of an anomaly management system 1 according to the first embodiment. The anomaly management system 1 is mounted on a vehicle 10. The anomaly management system 1 includes, for example, one or more cameras 11 (hereinafter, simply referred to as “camera 11”), a position sensor 12, a hazard lamp 13, an HMI (Human Machine Interface) device 14, and an information processing device 15.

The camera 11 captures an image of the surroundings of the vehicle 10. The position sensor 12 detects a position and an orientation of the vehicle 10. The position sensor 12 includes, for example, a global navigation satellite system (GNSS) receiver. The hazard lamp 13 is attached to the body of the vehicle 10. The HMI device 14 is, for example, a touch panel. In addition, a combination of the camera 11 and the information processing device 15 corresponds to an example of a drive recorder.

The information processing device 15 includes a communication device 16, one or more processors 17 (hereinafter, simply referred to as “processor 17”), and one or more memory devices 18 (hereinafter, simply referred to as “memory device 18”). The communication device 16 communicates with the outside of the vehicle 10 (including the notification destination 100) via a communication network.

The processor 17 executes various kinds of processing including processing (see FIG. 1) related to management (detection and notification) of the anomaly event. Examples of the processor 17 include a central processing unit (CPU), a graphics processing unit (GPU), an application specific integrated circuit (ASIC), and a field-programmable gate array (FPGA). The processor 17 may also be referred to as “circuitry” or “processing circuitry”. The “circuitry” is hardware that is programmed to perform the recited functions or that performs the functions. The memory device 18 stores various kinds of information. Examples of the memory device 18 include a volatile memory, a nonvolatile memory, a hard disk drive (HDD), and a solid state drive (SSD). The processor 17 reads the various kinds of information from the memory device 18 and stores the various kinds of information in the memory device 18. The functions of the information processing device 15 may be implemented by cooperation between the processor 17 that executes a computer program and the memory device 18. The computer program is stored in the memory device 18. Alternatively, the computer program may be recorded in a non-transitory computer-readable recording medium or may be provided via a network.

Moreover, the memory device 18 stores information, such as driving environment information, the anomaly event information, and notification destination information. The driving environment information is information indicating a driving environment of the vehicle 10. The driving environment information includes, for example, the video V captured by the camera 11, position information indicating the position and the orientation of the vehicle 10 acquired by the position sensor 12, and time information acquired by a count timer included in the processor 17 for time management. The driving environment information is used as the anomaly event information. The anomaly event information is as described above. The notification destination information includes information indicating a correspondence between each anomaly event and the notification destination 100 and information necessary for communication with each notification destination.

### 1-2. Management of Anomaly Event

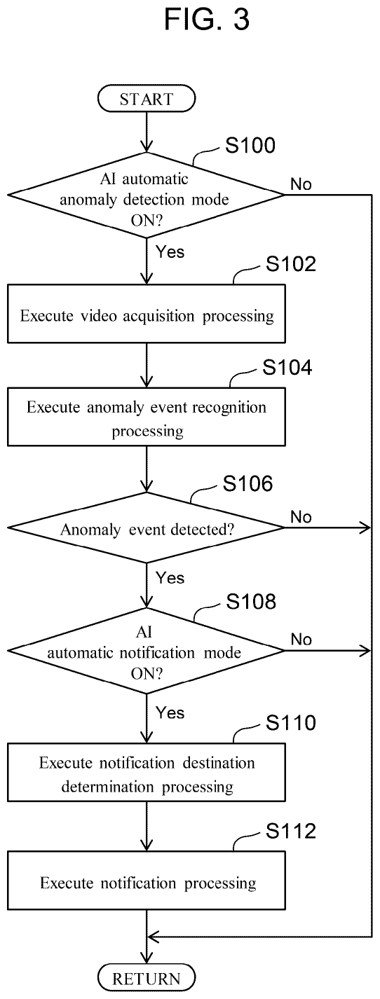

FIG. 3 is a flowchart illustrating an example of a flow of processing related to the management of the anomaly event according to the first embodiment. The processing of this flowchart is executed by the information processing device 15 (processor 17).

In step S100, the information processing device 15 determines whether or not an AI automatic anomaly detection mode is ON. The AI automatic anomaly detection mode is a mode in which the vehicle 10 automatically detects an anomaly event using an AI technology. The ON/OFF of the AI automatic anomaly detection mode is switched by, for example, a driver of the vehicle 10 who operates the HMI device 14. When the AI automatic anomaly detection mode is OFF (step S100; No), the processing proceeds to RETURN. On the other hand, when the AI automatic anomaly detection mode is ON (step S100; Yes), the processing proceeds to step S102.

In step S102, the information processing device 15 executes the video acquisition processing described above. That is, as described above, the information processing device 15 acquires a video V captured by the camera 11. The information processing device 15 stores the acquired video V of the camera 11 in the memory device 18. Thereafter, the processing proceeds to step S104.

In step S104, the information processing device 15 executes the anomaly event recognition processing described above. That is, as described above, the information processing device 15 automatically recognizes an anomaly event shown in the video V and the content (for example, type, situation, scale) of the anomaly event by using a machine learning model. The machine learning model is learned so as to output recognition results of an anomaly event and the content of the anomaly event from the input video V. The machine learning model is stored in the memory device 18 of the vehicle 10. The information processing device 15 stores, in the memory device 18, information indicating the content of the recognized anomaly event and position information indicating the position where the anomaly event is recognized. The information processing device 15 may also store, in the memory device 18, the time information indicating the point of time at which the anomaly event is recognized. After step S104, the processing proceeds to step S106.

In step S106, the information processing device 15 determines whether or not an anomaly event is detected (recognized) by the anomaly event recognition processing. As a result, when the anomaly event is not detected (step S106; No), the processing proceeds to RETURN. On the other hand, when the anomaly event is detected (step S106; Yes), the processing proceeds to step S108.

In addition, when the anomaly event is detected (step S106; Yes), the information processing device 15 may turn on the hazard lamp 13 of the vehicle 10 for a designated period of time, for example, to call attention to a vehicle behind the vehicle 10 (the target vehicle), depending on the content of the detected anomaly event. Further, when the anomaly event is not detected (step S106; No), the information processing device 15 may start storing the video V in the memory device 18 in response to the operation of the HMI device 14 by the driver who determines that the anomaly event has occurred. In the second embodiment described below, the video V may start to be stored in a memory device 33 of a management device 30 (cloud) in response to this kind of operation of the HMI device 14.

In step S108, the information processing device 15 determines whether or not an AI automatic notification mode is ON. The AI automatic notification mode is a mode in which the vehicle 10 automatically notifies of the anomaly event information using the AI technology. The ON/OFF of the AI automatic notification mode is switched by, for example, the driver of the vehicle 10 who operates the HMI device 14. When the AI automatic notification mode is OFF (step S108; No), the processing proceeds to RETURN. On the other hand, when the AI automatic notification mode is ON (step S108; Yes), the processing proceeds to step S110.

In step S110, the information processing device 15 executes the notification destination determination processing described above. That is, as described above, the information processing device 15 automatically determines an appropriate notification destination 100 according to the content of the anomaly event included in the anomaly event information. In addition, in an example in which a machine learning model is used to automatically determine the notification destination 100, the machine learning model is learned so as to output a notification destination 100 appropriate for the input anomaly event information. The machine learning model is stored in the memory device 18 of the vehicle 10. After step S110, the processing proceeds to step S112.

In step S112, the information processing device 15 executes the notification processing described above. That is, as described above, the information processing device 15 automatically transmits the anomaly event information to the determined notification destination 100. More specifically, for example, the information processing device 15 executes processing of verbalizing the anomaly event information and transmits information on the content and the position of the anomaly event to the notification destination 100. In addition, in an example in which the anomaly event information includes the video V captured in the target period of time described above, the information processing device 15 may also transmit information indicating an access method to the video V. Furthermore, when the anomaly event information includes the time information of the anomaly event, the information processing device 15 may also transmit the time information.

In addition, the information processing device 15 may transmit other useful information to the notification destination 100 together with the anomaly event information. Examples of the useful information mentioned here include current position information (i.e., position information at the time of notification) of at least one of a vehicle (at least one of the target vehicle and another vehicle) and a person that are related to the anomaly event, and information of current local weather or weather forecast.

### 1-3. Effect

As described above, according to the anomaly management system 1 of the first embodiment, the anomaly event is automatically recognized from the video V captured by the camera 11 and the notification is automatically performed. Therefore, the driver who is driving does not need to perform the notification. Also, the notification destination 100 according to the content of the anomaly event is automatically determined, and the notification is appropriately performed to the appropriate notification destination 100. Therefore, a notification delay and an unnecessary confusion are reduced or prevented. Further, the anomaly event information including the content and the position of the anomaly event is automatically transmitted to the notification destination 100. Therefore, the driver does not need to explain each anomaly event one by one. This is particularly effective when it is difficult for the driver to explain the accurate position and content of the anomaly event.

Furthermore, the anomaly event information may include the video V captured in the target period of time including at least the timing at which the anomaly event is recognized. This further facilitates the understanding of the situation of the anomaly event.

### 2. Second Embodiment

### 2-1. Configuration Example

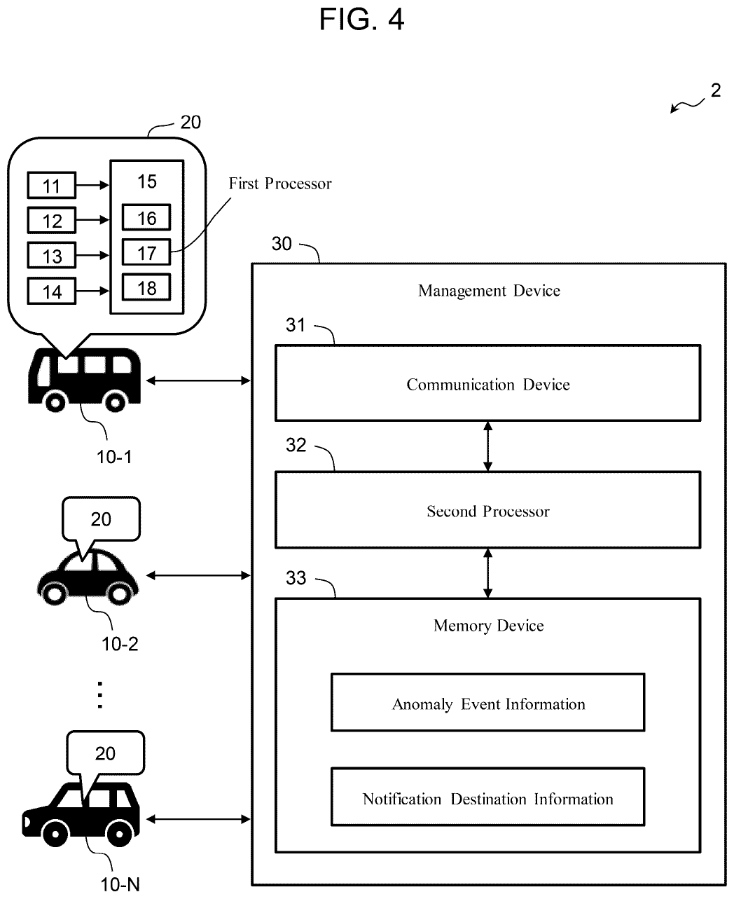

FIG. 4 is a block diagram showing a configuration example of an anomaly management system 2 according to the second embodiment. The anomaly management system 2 includes a plurality of in-vehicle systems 20 respectively mounted on a plurality of vehicles 10 (10-1 to 10-N: N is an integer greater than or equal to 2) and a management device 30. The in-vehicle system 20 mentioned here includes, for example, the camera 11, the position sensor 12, the hazard lamp 13, the HMI device 14, and the information processing device 15, similarly to the configuration illustrated in FIG. 2. It should be noted that, in the second embodiment, the one or more processors 17 included in the information processing device 15 correspond to an example of “one or more first processors” or “first processing circuitry” according to the present disclosure, and are hereinafter simply referred to as “first processor 17”.

The management device 30 includes a communication device 31, one or more second processors 32 (hereinafter, simply referred to as “second processor 32”), and one or more memory devices 33 (hereinafter, simply referred to as “memory device 33”). The communication device 31 communicates with the outside of the management device 30 (including the plurality of vehicles 10 and the notification destination 100) via a communication network. The management device 30 is a management server (for example, a cloud server) that manages the anomaly events received from the plurality of vehicles 10.

In the second embodiment, the first processor 17 executes various kinds of processing including processing related to management (detection) of the anomaly event. Also, the second processor 32 executes various kinds of processing including processing related to management (notification) of the anomaly event.

Examples of the second processor 32 include a CPU, a GPU, an ASIC, and an FPGA. The second processor 32 may also be referred to as “second circuitry” or “second processing circuitry”. The “second circuitry” is hardware that is programmed to perform the recited functions or that performs the functions. The memory device 33 stores various kinds of information. Examples of the memory device 33 include a volatile memory, a nonvolatile memory, an HDD, and an SSD. The second processor 32 reads the various kinds of information from the memory device 33 and stores the various kinds of information in the memory device 33. The functions of the management device 30 may be implemented by cooperation between the second processor 32 that executes a computer program and the memory device 33. The computer program is stored in the memory device 33. Alternatively, the computer program may be recorded in a non-transitory computer-readable recording medium or may be provided via a network. The memory device 33 also stores information, such as the anomaly event information and the notification destination information. Additionally, in the second embodiment, the memory device 18 of the vehicle 10 may not store the notification destination information.

### 2-2. Management of Anomaly Event

According to the anomaly management system 1 of the first embodiment described above, the information processing device 15 of the vehicle 10 that has detected an anomaly event transmits the anomaly event information to the notification destination 100. As a result, the anomaly event information on the same anomaly event may be transmitted to the notification destination 100 from a plurality of vehicles 10 on which the anomaly management system 1 is mounted. That is, a large number of notifications relating to the same anomaly event may be transmitted. In order to prevent the number of notifications from increasing unnecessarily, in the anomaly management system 2 according to the second embodiment, the following “selective notification processing” is executed as the “notification processing”.

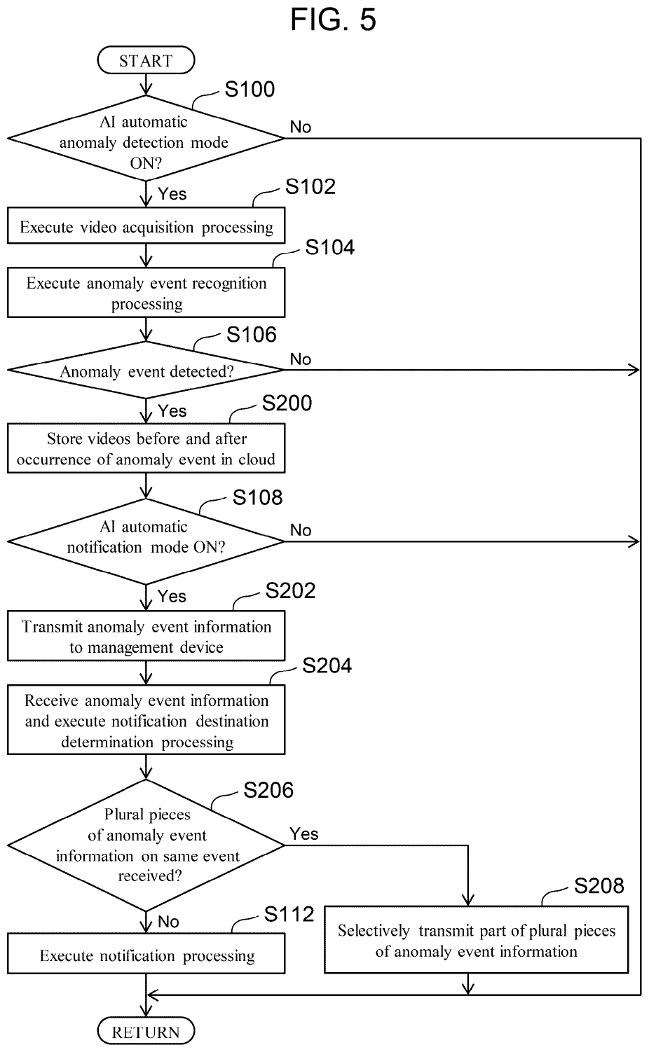

FIG. 5 is a flowchart illustrating an example of a flow of processing related to the management of the anomaly event according to the second embodiment. The processing of this flowchart is executed by the information processing device 15 (first processor 17) and the management device 30 (second processor 32) in cooperation with each other. This processing is different from the processing shown in FIG. 3 in the points described below.

Specifically, as in the processing shown in FIG. 3, the information processing device 15 (first processor 17) of the vehicle 10 executes the video acquisition processing and the anomaly event recognition processing (steps S102 and S104). In FIG. 5, when an anomaly event is detected thereafter (step S106; Yes), the processing proceeds to step S200.

In step S200, processing of storing the video V before and after the occurrence of the anomaly event in the management device (cloud) 30 is executed. Specifically, the information processing device 15 transmits to the management device 30, the video V before and after the occurrence of the anomaly event stored in the memory device 18. The management device 30 receives the video V and stores the received video V in the memory device 33. It should be noted that, in an example in which the video V is included in the anomaly event information transmitted to the notification destination 100, the processing of step S200 corresponds to a part of the processing of transmitting and receiving the anomaly event information.

In step S108 subsequent to step S200, when the AI automatic notification mode is ON, the processing proceeds to step S202. In step S202, the information processing device 15 transmits to the management device 30, the anomaly event information related to the anomaly event detected (recognized) in step S106. More specifically, the transmitted anomaly event information includes at least the information indicating the content of the anomaly event and the position information. The transmitted anomaly event information may include the time information of the anomaly event. Thereafter, the processing proceeds to step S204.

In step S204, the management device 30 (second processor 32) receives the anomaly event information from the vehicle 10 and stores the received anomaly event information in the memory device 33. The management device 30 then executes the notification destination determination processing based on the received anomaly event information. Thereafter, the processing proceeds to step S206.

The processing of steps S206 and S208 correspond to an example of the “selective notification processing” described above. In step S206, the management device 30 determines whether or not plural pieces of anomaly event information on the same anomaly event have been received (determination processing). This determination processing may be executed based on, for example, the position information and the time information of the anomaly event included in the anomaly event information. More specifically, for example, the management device 30 may determine that a plurality of anomaly events that fall within a designated distance range and fall within a designated time range are the same.

When the plural pieces of anomaly event information on the same anomaly event are not received (step S206; No), the management device 30 executes the same notification processing as the processing illustrated in FIG. 3 (step S112). On the other hand, when the plural pieces of anomaly event information have been received (step S206; Yes), the processing proceeds to step S208.

In step S208, the management device 30 selectively transmits a part of the plural pieces of anomaly event information on the same anomaly event to the notification destination 100. The selective notification processing will be described below in detail.

### 2-3. Details of Selective Notification Processing

Next, first to fifth examples of the selective notification processing will be described in order.

### 2-3-1. First Example

In the first example, when the plural pieces of anomaly event information on the same anomaly event include “first anomaly event information that arrives at the management device 30 at a first point of time” and “second anomaly event information that arrives at the management device 30 at a second point of time later than the first point of time”, the management device 30 performs the notification as follows. That is, the management device 30 transmits the first anomaly event information to the notification destination 100, and refrains from transmitting (that is, does not transmit) the second anomaly event information to the notification destination 100. As described above, in the first example, the management device 30 is configured not to notify the temporally subsequent one of the plural pieces of anomaly event information for the same anomaly event.

More specifically, the first anomaly event information transmitted to the notification destination 100 may be, for example, the first acquired anomaly event information among the plural pieces of anomaly event information on the same anomaly event. That is, the management device 30 may be configured to notify the notification destination 100 of only the earliest one of the plural pieces of anomaly event information and not to notify the notification destination 100 of the subsequent pieces of anomaly event information. Alternatively, the first anomaly event information may be a fixed number of two or more pieces of anomaly event information that respectively arrives at the management device 30 at the fixed number of two or more first points of times before the second point of time. That is, the management device 30 may be configured to perform the fixed number of two or more notifications and not to perform one or more notifications for the subsequent one or more pieces of anomaly event information.

Alternatively, the management device 30 may control the transmission of the plural pieces of anomaly event information on the same anomaly event to the notification destination 100 such that the frequency of notification decreases with a lapse of time.

### 2-3-2. Second Example

In the second example, when the plural pieces of anomaly event information on the same anomaly event include “first anomaly event information that arrives at the management device 30 at a first point of time and includes a first video as the video V” and “second anomaly event information that arrives at the management device 30 at a second point of time later than the first point of time and includes a second video as the video V”, the management device 30 performs the notification as follows. That is, the management device 30 transmits the first anomaly event information to the notification destination 100. Also, the management device 30 calculates a degree of difference between the first video and the second video based on the first video and the second video. When the calculated degree of difference exceeds a threshold value, the management device 30 transmits the second anomaly event information to the notification destination 100. On the other hand, when the calculated degree of difference is equal to or lower than the threshold value, the management device 30 refrains from transmitting the second anomaly event information to the notification destination 100. As described above, in the second example, if the anomaly event information is related to the same anomaly event but there is a difference in the content or the aspect of the information, the management device 30 is configured to perform the subsequent notification.

More specifically, in the second example, the management device 30 recognizes, based on the first anomaly event information, a first imaging direction that is a direction in which the first video is captured, and recognizes, based on the second anomaly event information, a second imaging direction that is a direction in which the second video is captured. The management device 30 then increases the degree of difference when the difference between the first imaging direction and the second imaging direction increases. Therefore, according to the second example, if the anomaly event information is related to the same anomaly event but the imaging direction is largely different between the first video and the second video, the second anomaly event information is transmitted to the notification destination 100. On the other hand, if the anomaly event information is related to the same anomaly event but the difference in the imaging direction is small, the second anomaly event information is not transmitted.

In addition, the imaging direction of the video V can be estimated by, for example, the following method. That is, the anomaly event information may include information indicating the position and orientation of the vehicle 10 equipped with the camera 11 that captures the video V. Then, the management device 30 may estimate the imaging direction of the video V based on the position and the direction of the vehicle 10.

### 2-3-3. Third Example

The third example is the same as the second example in that the “degree of difference” is used to determine whether or not to transmit the second anomaly event information to the notification destination 100. In the third example, the management device 30 calculates, based on the first anomaly event information, a first degree of severity that is the degree of severity of the same anomaly event, and calculates, based on the second anomaly event information, a second degree of severity that is the degree of severity of the same anomaly event. The management device 30 then increases the degree of difference when the amount of increase from the first severity to the second severity increases. Therefore, according to the third example, if the anomaly event information is related to the same anomaly event but the degree of severity is remarkably increased, the second anomaly event information is transmitted to the notification destination 100. On the other hand, if the anomaly event information is related to the same anomaly event but the degree of severity does not increase, the second anomaly event information is not transmitted.

In addition, the degree of severity indicates the scale, degree, or intensity of the anomaly event. For example, when the anomaly event is a fire in a building, the degree of severity increases in accordance with the spread of the fire. For example, the degree of severity may be calculated by the information processing device 15 of the vehicle 10 based on the content of the anomaly event recognized by the anomaly event recognition processing. Then, the calculated degree of severity may be included in the anomaly event information and provided to the management device 30. Alternatively, the degree of severity may be calculated by the management device 30 using the video V included in the anomaly event information and a machine learning model.

### 2-3-4. Fourth Example

In the fourth example, the management device 30 determines (confirms) whether or not a person who deals with an anomaly event has arrived at the scene of the anomaly event. This determination can be made based on, for example, the result of communication with the notification destination 100 that has received the anomaly event information for the anomaly event. If the person has arrived at the scene, the management device 30 refrains from transmitting new anomaly event information (that is, subsequent notification) to the notification destination 100 when receiving the new anomaly event information on the same anomaly event as the anomaly event described above.

### 2-3-5. Fifth Example

In the fifth example, when information indicating that subsequent notification is unnecessary for the notified anomaly event is received from the notification destination 100, the management device 30 is configured not to perform further notification for the same anomaly event as the notified anomaly event.

Moreover, when a response to the transmission of the anomaly event information is received from the notification destination 100, the management device 30 may feed back the content of the response to the anomaly event recognition processing in order to reduce the number of future notifications. To be specific, in an example in which the response includes the above-described “information indicating that subsequent notification is not necessary for the notified anomaly event”, the management device 30 may request “one or more feedback target vehicles 10X which have not yet transmitted to the management device 30, the anomaly event information related to the anomaly event” to execute the anomaly event recognition processing in such a way as not to recognize (detect) the anomaly event. Further, in an example in which the response includes “information indicating that the content of the notification (that is, the content of the anomaly event information transmitted to the notification destination 100) is not appropriate”, the management device 30 may request the one or more feedback target vehicles 10X to perform the anomaly event recognition processing in such a way as not to recognize the anomaly event with the content determined to be inappropriate by the notification destination 100. Furthermore, in an example in which the response includes “information indicating that the imaging direction or the degree of severity described above is not appropriate for the anomaly event for which the notification has been made a plurality of times”, the management device 30 may request the one or more feedback target vehicles 10X to perform the anomaly event recognition processing in such a way as not to recognize the anomaly event in the imaging direction or with the degree of severity determined to be inappropriate by the notification destination 100. Additionally, for example, the management device 30 may specify, as the one or more feedback target vehicles 10X, one or more vehicles 10 existing within a designated distance range from the position of the anomaly event related to the response.

### 2-4. Effect

The anomaly management system 2 according to the second embodiment described above also provides the same effects as those described in Section 1-3 for the anomaly management system 1 according to the first embodiment.

In addition, according to the selective notification processing executed in the anomaly management system 2, when there are plural pieces of anomaly event information on the same anomaly event, not all of the plural pieces of anomaly event information but only a part thereof is selectively notified. This prevents an unnecessarily large number of notifications from being transmitted to the notification destination 100. This contributes to reducing processing load and preventing confusion.

What is claimed is:

1. An anomaly management system, comprising
processing circuitry configured to execute:
video acquisition processing of acquiring a video captured by a camera mounted on a moving body;
anomaly event recognition processing of automatically recognizing an anomaly event shown in the video and content of the anomaly event by using a machine learning model;
notification destination determination processing of automatically determining a notification destination according to the content of the anomaly event; and
notification processing of automatically transmitting to the notification destination, anomaly event information including at least information indicating the content of the anomaly event and position information indicating a position of the anomaly event.

2. The anomaly management system according to claim 1, wherein
the anomaly event information includes the video captured in a target period of time including at least a timing at which the anomaly event is recognized.

3. The anomaly management system according to claim 1, wherein
the processing circuitry includes:
first processing circuitry included in a plurality of information processing devices respectively mounted on a plurality of moving bodies; and
second processing circuitry included in a management device configured to communicate with the plurality of information processing devices,
the first processing circuitry of each of the plurality of moving bodies is configured to:
execute the video acquisition processing and the anomaly event recognition processing; and
transmit the anomaly event information to the management device, and
the second processing circuitry is configured to:
receive the anomaly event information from each of the plurality of moving bodies;
execute the notification destination determination processing; and
execute, as the notification processing, determination processing of determining whether or not the management device has received plural pieces of anomaly event information on a same anomaly event, and processing of selectively transmitting to the notification destination, a part of the plural pieces of anomaly event information on the same anomaly event when the management device has received the plural pieces of anomaly event information.

4. The anomaly management system according to claim 3, wherein
the anomaly event information includes time information indicating a point of time at which the anomaly event is recognized, and
in the determination processing, based on the position information and the time information, the second processing circuitry determines whether or not the management device has received the plural pieces of anomaly event information on the same anomaly event.

5. The anomaly management system according to claim 3, wherein
the plural pieces of anomaly event information on the same anomaly event include:
first anomaly event information that arrives at the management device at a first point of time; and
second anomaly event information that arrives at the management device at a second point of time later than the first point of time, and
the second processing circuitry is configured to transmit the first anomaly event information to the notification destination and refrain from transmitting the second anomaly event information to the notification destination.

6. The anomaly management system according to claim 3, wherein
the anomaly event information includes videos captured in a target period of time including at least a timing at which the anomaly event is recognized,
the plural pieces of anomaly event information on the same anomaly event include:
first anomaly event information that arrives at the management device at a first point of time and includes a first video as one of the videos; and
second anomaly event information that arrives at the management device at a second point of time later than the first point of time and includes a second video as another of the videos, and
the second processing circuitry is configured to:
transmit the first anomaly event information to the notification destination;
based on the first video and the second video, calculate a degree of difference between the first video and the second video;
when the degree of difference is higher than a threshold value, transmit the second anomaly event information to the notification destination; and
when the degree of difference is equal to or lower than the threshold value, refrain from transmitting the second anomaly event information to the notification destination.
